(19) United States
(12) Patent Application Publication
(10) Pub. No.: US 2009/0206655 A1
(43) Pub. Date: Aug. 20, 2009

(54) Clawler Without Steel Cores

(76) Inventor: In-Hyuk Song, Daejeon-City (KR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 11/887,794

(22) PCT Filed: Sep. 26, 2005
(86) PCT No.: PCT/KR2005/003191

§ 371 Date: Dec. 30, 2008

(30) Foreign Application Priority Data
Apr. 21, 2005 (KR) 10- 2005 -0033030

(51) Int. Cl. B62D 55/253

(52) U.S. Cl. 305/169

(57) ABSTRACT

The present invention relates to a crawler without steel cores (hereinafter referred to as “coreless crawler”), which is used for transporting means of caterpillar vehicles for construction, civil engineering, agricultural use or the like. More particularly, this invention relates to a coreless crawler, in which a first and second separation preventing cables, having the same but opposite directional oblique angle, form a unitary layer by being woven, thereby improving the flexibility and increasing binding forces between the cables, so that separation of the crawler can be effectively prevented.

### TECHNICAL FIELD

The present invention relates to a crawler without steel cores (hereinafter, referred to as “coreless crawler”), which is used for transporting the caterpillar vehicles for construction, civil engineering, agricultural use or the like. More particularly, this invention relates to a coreless crawler for preventing the crawler body from being separated from a sprocket or wheel, in which a first and second separation preventing cables, having the same but opposite directional oblique angle, form a unitary layer by being woven, thereby improving the flexibility and increasing binding forces between the cables, so that separation of the crawler can be effectively prevented.

### BACKGROUND ART

A conventional crawler is suspended between a driving sprocket and an idler, and is given the forwarding force by the driving sprocket's rotation.

The respective teeth of the driving sprocket are inserted in sprocket pits formed continually at the center of a crawler at regular intervals. Conventionally, since the crawler is made from rubber material so that the spaces between the sprocket pits are easily broken, the crawler cannot fulfill the duty of smoothly transferring the driving power.

To avoid this problem, conventionally, steel cores have been inserted between the respective sprocket pits so that smooth driving could be achieved, and guide rollers, which has been equipped at the outer side of guide projections formed at the cores, have prevented the crawler from leaving the driving sprocket and the idler during the operation of the crawler.

However, when the conventional crawler, in which steel cores are included, is destroyed by fire for disposal, the cores are not burn up, and this causes additional rework for disposal. Further, the increased weight of the crawler due to the cores reduces the fuel efficiency, and the separation of the crawler occurs more frequently than a general sprocket-driving type.

In addition, since the friction between the metallic sprocket and the steel cores accelerates the abrasion, the lifetime of the product becomes short.

Accordingly, coreless crawler has been recently spreading to avoid such problems occurring when using a conventional crawler with steel cores.

However, in the case of the coreless crawler, it is a key point that the separation of the crawler is prevented during operation because the steel cores are not included in the crawler. If a mechanism for preventing separation of the crawler is not well furnished, the crawler cannot accomplish its proper performance. This is a critical problem in the crawler.

A conventional coreless crawler 1 having a function of preventing its separation has been suggested as shown in FIGS. 8 and 9.

In construction, the conventional coreless crawler 1 is composed of a plurality of rugs 3 attached to an outward surface of the crawler body 2, so that they come into contact with the ground; a plurality of guide projections, not shown, arrayed along a central line of an inward surface of the body 2 at regular intervals; and parallel main cables 4 for supporting the driving stress, which are repetitively wound many times inside the crawler body 2 in the direction of driving.

Additionally, first separation preventing cables 5 are inserted in the body 2 so that they are layered on the surface of the main cables 4, each of which has a given oblique angle. Second separation preventing cables 6 are inserted in the body 2 so that they are layered on the surface of the first separation preventing cables 5, each of which has an oblique angle identical to but in the opposite direction of that of the first separation preventing cables 5. Lateral tension reinforcing cables 7 are inserted in the body 2 so that they are layered on the surface of the second separation preventing cables 6, each of which has an angle substantially perpendicular to an axial line of the crawler's driving direction.

However, in the conventional coreless crawler 1 for preventing separation, since a pair of first and second separation preventing cables 5, 6 having the same but opposite directional oblique angle are separate into individual layers, the flexibility of the crawler is deteriorated, and additionally, when the crawler goes on an obstacle projecting from the ground, the obstacle may penetrate the crawler body to the separation preventing cables, thereby damaging the crawler or causing the separation preventing cables to delaminate.

Moreover, as the binding force between the cables is lowered and thereby becomes loose, the possibility of separation during operation is highly increased. Further, once the separation preventing cables are partially broken, the successive further breakage propagates.

### DISCLOSURE OF INVENTION

### Technical Problem

Therefore, the present invention has been made to solve the above-mentioned problems involved in the conventional coreless crawler, and it is an object of the present invention to provide a coreless crawler in which a layer of a first and second separation preventing cables having the same oblique angle in the opposite direction are woven and interposed between a main cable layer and a lateral tension reinforcing cable layer, thereby improving the flexibility and increasing the binding forces between the separation preventing cables, and effectively preventing separation of the crawler.

### Technical Solution

To achieve the above object, according to the present invention, there is provided a crawler without steel cores, including: main cables repetitively wound many times inside a crawler body in the direction of driving; first and second separation preventing cables inserted inside the crawler body so as to be layered on the main cables; and lateral tension reinforcing cables inserted inside the crawler body so as to be layered on the first and second separation preventing cables so that they are across the crawler's driving direction, whereby the first and second separation preventing cablesare woven so that they form a same layer integrally.

### ADVANTAGEOUS EFFECTS

According to the present invention, since a first and second separation preventing cables having the same oblique angle in the opposite direction are woven to form a unitary layer rather than individual different layers, the flexibility of the crawler can be improved and, when the crawler goes on an obstacle, the obstacle cannot penetrate the crawler body so that the separation preventing cables are prevented from being damaged or being delaminated.

In addition, since the binding forces between the separation preventing cables are increased and they do not move at all, separation can be securely prevented, and further, if the separation preventing cables are broken, the successive further breakage does not propagate and be restricted the relevant spot, thereby remarkably lengthen the lifetime of the crawler.

### BRIEF DESCRIPTION OF THE DRAWINGS

The above and other objects, features, and advantages of the present invention will become more apparent from the following description when taken in conjunction with the accompanying drawings, in which:

FIG. 1 is a partially cutaway perspective view showing one embodiment of a crawler to which the present invention is adapted,

FIG. 2 is a partially cutaway plan view of the present invention,

FIG. 3 shows that separation preventing cables are alternately woven,

FIG. 4 shows the order of disposition of the separation preventing cables according to the present invention,

FIG. 5 is a partially cutaway perspective view showing another embodiment of a crawler to which the present invention is adapted,

FIG. 6 is a partially cutaway plan view according to another embodiment of the present invention,

FIG. 7 shows the order of disposition of the separation preventing cables according to another embodiment of the present invention,

FIG. 8 is a partially cutaway perspective view showing a conventional coreless crawler, and

FIG. 9 is a partially cutaway plan view showing a conventional coreless crawler.

### BRIEF DESCRIPTION OF REFERENCE NUMBER

2: crawler body
3: lug
4: main cable
5: the first separation preventing cable
6: the second separation preventing cable
7: lateral tension reinforcing cable

### BEST MODE FOR CARRYING OUT THE INVENTION

Hereinafter, preferred embodiments of the present invention will be described in detail with reference to the attached drawings.

With reference to FIG. 1, the basic construction of a coreless crawler according to the present invention includes a plurality of rugs 3 formed on an outward surface of a crawler body 2 so that they come into contact with the ground; a plurality of guide projections arrayed on an inward surface of the body 2; main cables 4 repetitively wound many times inside the crawler body 2 in the vicinity of the inward surface in the direction of driving; a first and second separation preventing cables 5, 6 layered on the main cables 4; and lateral tension reinforcing cables 7 layered on the first and second separation preventing cables 5, 6, so that they are across an axial line of the crawler's driving direction.

Such a coreless crawler 1 according to the present invention is dominantly characterized in that the first and second separation preventing cables 5, 6 are woven so that they form a same layer integrally.

To implement the above construction that the different first and second separation preventing cables 5, 6 form a unitary layer, referring to FIG. 3, each of the first and the second separation preventing cables 5, 6 are grouped into a plurality of cables arrayed at equal intervals and forming a given width, L, and a group of the first separation preventing cables 5 and a group of the second separation preventing cables 6 are woven alternately.

Here, it is preferable that the first and second separation preventing cables 5, 6 are disposed with the same oblique angle in the opposite direction, so that they prevent separation by balancing deflection force occurring when the crawler drives.

In addition, it is more preferable that the oblique angle is within the range of 30 to 80° with regard to an axial line of the crawler's driving direction.

If the angle is less than 30°, the flexibility of the crawler is degraded, while if the angle is more than 80°, the fundamental purpose for preventing separation cannot be fulfilled.

Hereinafter, the preferred embodiments for variously implementing such constructed first and second separation preventing cables 5, 6 in order to reinforce the binding force and securely prevent separation are described in detail.

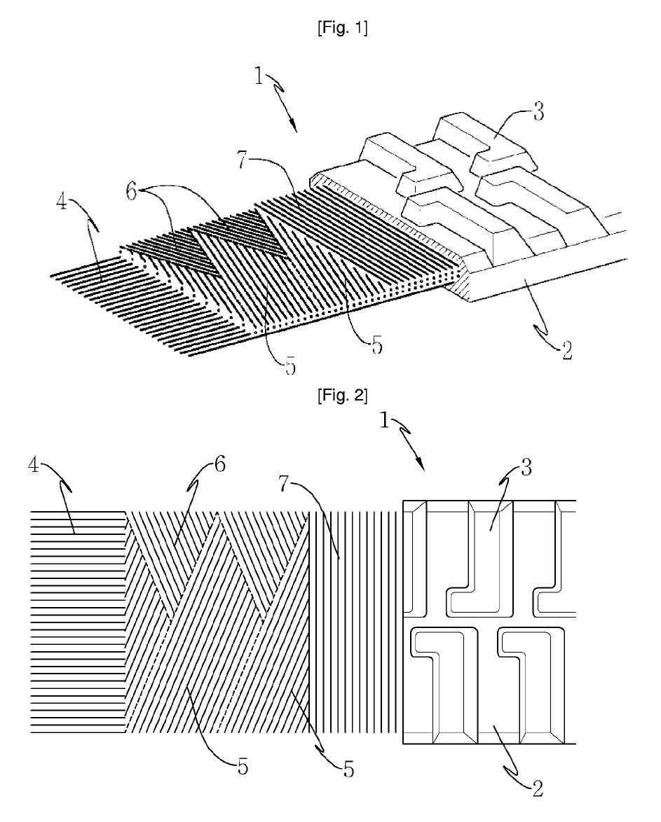

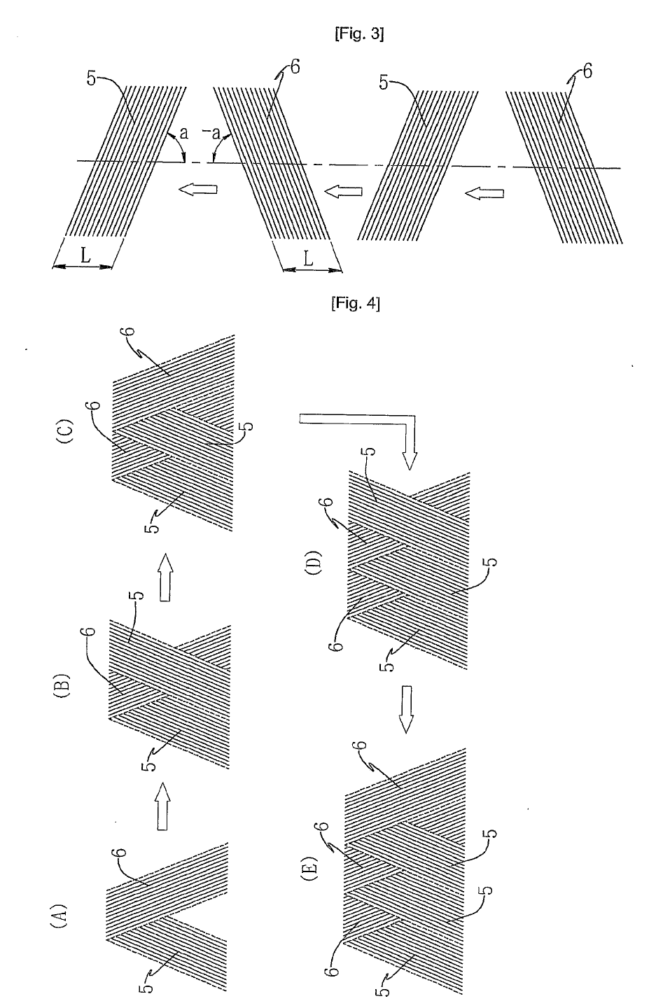

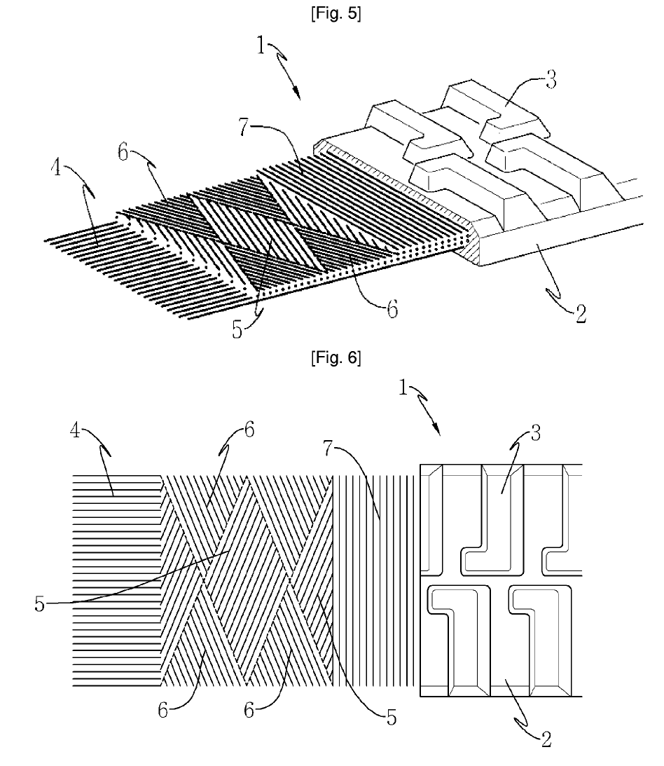

First of all, the present invention may be implemented by the construction shown in FIGS. 1 and 2. This may be implemented through the sequence like in FIG. 4 which shows that a group of first separation preventing cables 5 and a group of second separation preventing cables 6 are alternately disposed.

In FIG. 4 (a), a first group of second separation preventing cables 6 is disposed on a first group of first separation preventing cables 5 so as to overlap with one end portion thereof, and in (b), a second group of first separation preventing cables 5 is disposed on a first group of second separation preventing cables 6 so as to overlap with a central portion thereof. Similarly, as in (c), a second group of second separation preventing cables 6 is disposed on a second group of first separation preventing cables 5 so as to overlap with one end portion thereof.

Successively, a structure that, as shown in (d), a third group of first separation preventing cables 5 is disposed on the second group of second separation preventing cables 6 so as to overlap with a central portion thereof, and simultaneously on the first group of second separation preventing cables 6 so as to overlap with an opposite end portion thereof, and a structure that, as shown in (e), a third group of second separation preventing cables 6 is disposed on the third group of first separation preventing cables 5 so as to overlap with one end thereof, are alternately woven into a unitary layer structure.

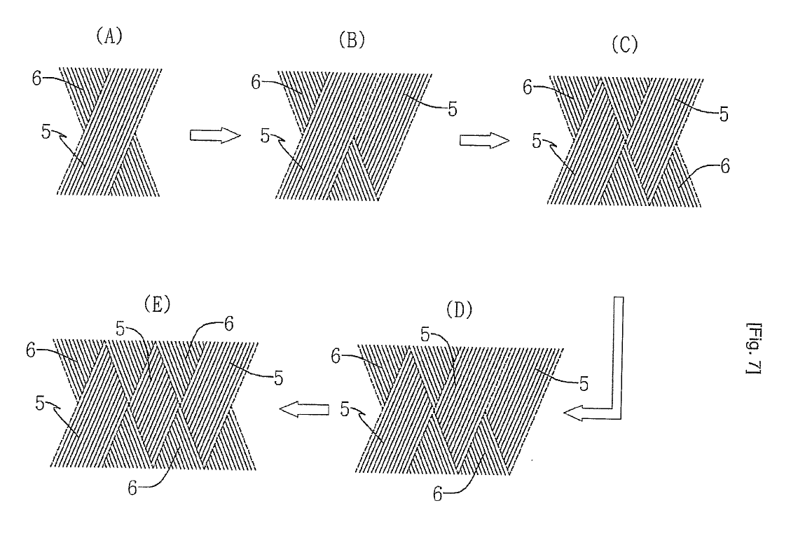

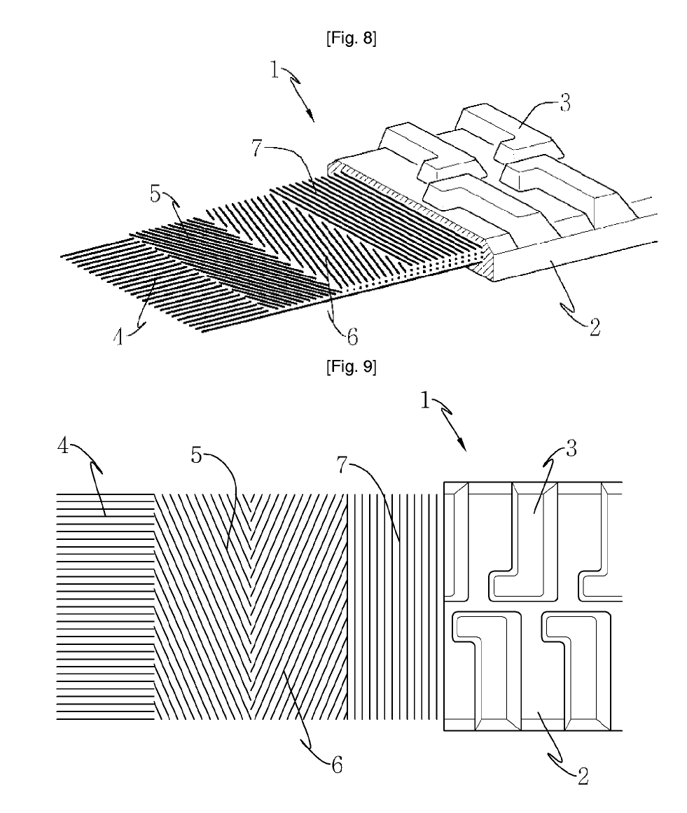

FIGS. 5 and 6 show another embodiment of the present invention, and FIG. 7 shows a process for achieving this embodiment, in which a group of first separation preventing cables 5 and a group of second separation preventing cables 6 are alternately disposed.

In FIG. 7 (a), a first group of second separation preventing cables 6 is disposed beneath a first group of second separation preventing cables 6 so as to overlap with a central portion thereof, and in (b), a second group of first separation preventing cables 5 is disposed beneath the first group of second separation preventing cables 6 so as to overlap with one end thereof.

Successively, a structure that, as in (c), a second group of second separation preventing cables 6 is disposed beneath the second group of first separation preventing cables 5 so as to overlap with a central portion thereof, and simultaneously on the first group of first separation preventing cables 6 so as to overlap with an opposite end portion thereof, and a structure that, as in (d), a third group of first separation preventing cables 5 is disposed beneath the second group of second separation preventing cables 5 so as to overlap with one end thereof, are alternately woven into a unitary layer structure as shown in FIG. 7 (e).

From the foregoing, according to the present invention, while in the conventional art the individual layers of the separation preventing cables form two different layers, the first and second separation preventing cables 5, 6 according to the present invention form a unitary layer by being woven alternately, so that two different separation preventing cables are formed in a single layer. Thereby the flexibility can be improved, separation can be effectively prevented, and durability of the crawler can be remarkably increased.

1. A crawler without steel cores, comprising:
main cables(4) repetitively wound many times inside a crawler body(2) in the direction of driving;
first and second separation preventing cables(5,6) inserted inside the crawler body so as to be layered on the main cables(4); and
lateral tension reinforcing cables(7) inserted inside the crawler body(2) so as to be layered on the first and second separation preventing cables(5,6) so that they are across the crawler's driving direction,
whereby the first and second separation preventing cables(5,6) are woven so that they form a same layer integrally.

2. The crawler according to claim 1, wherein the respective first and second separation preventing cables (5,6) are grouped into a plurality of cables arranged at equal intervals and forming a predetermined width (L), and a group of the first separation preventing cables (5) and a group of the second separation preventing cables (6) are woven alternately.

3. The crawler according to claim 2, wherein a first group of second separation preventing cables (6) is disposed on a first group of first separation preventing cables (5) so as to overlap with one end portion thereof, a second group of first separation preventing cables (5) is disposed on a first group of second separation preventing cables (6) so as to overlap with a central portion thereof, and a second group of second separation preventing cables (6) is disposed on a second group of first separation preventing cables (5) so as to overlap with one end portion thereof, and
wherein a structure that a third group of first separation preventing cables (5) is disposed on the second group of second separation preventing cables (6) so as to overlap with a central portion thereof, and simultaneously on the first group of second separation preventing cables (6) so as to overlap with an opposite end portion thereof, and a structure that a third group of second separation preventing cables (6) is disposed on the third group of first separation preventing cables (5) so as to overlap with one end thereof, are alternately woven into a unitary layer structure.

4. The crawler according to claim 2, wherein a first group of second separation preventing cables (6) is disposed beneath a first group of second separation preventing cables (6) so as to overlap with a central portion thereof, and a second group of first separation preventing cables (5) is disposed beneath the first group of second separation preventing cables (6) so as to overlap with one end thereof, and
wherein a structure that a second group of second separation preventing cables (6) is disposed beneath the second group of first separation preventing cables (5) so as to overlap with a central portion thereof, and simultaneously on the first group of first separation preventing cables (6) so as to overlap with an opposite end portion thereof, and a structure that a third group of first separation preventing cables (5) is disposed beneath the second group of second separation preventing cables (5) so as to overlap with one end thereof, are alternately woven into a unitary layer structure.

5. The crawler according to any one of claims 1 to 4, wherein the first and second separation preventing cables (5,6) have the same oblique angle in the opposite direction.

6. The crawler according to any one of claims 1 to 4, wherein the first and second separation preventing cables (5,6) have the oblique angle within the range of 30 to 80° with regard to an axial line of the crawler's driving direction.
